(19) United States
(12) Patent Application Publication
(10) Pub. No.: US 2008/0224955 A1
(43) Pub. Date: Sep. 18, 2008

(54) PLASMA DISPLAY PANEL WITH HIGH BRIGHTNESS

(75) Inventors: Hsu-Pin KAO, Pingjhen City (TW); Jang-Jeng Liang, Taoyuan City (TW); Tsan-Hung Tsai, Sanchong City (TW); Hsu-Chia Kao, Pingjhen City (TW)

Correspondence Address: Muncy, Geissler, Olds & Lowe, PLLC, P.O. BOX 1364, FAIRFAX, VA, 22038-1364, US

(73) Assignee: MARKETECH INTERNATIONAL CORP.

(21) Appl. No.: 12/048,930

(22) Filed: Mar. 14, 2008

(30) Foreign Application Priority Data
Mar. 16, 2007 (TW) 096109050

(51) Int. Cl. G09G 3/28

(52) U.S. Cl. 345/60

(57) ABSTRACT

A plasma display panel is provided. The plasma display panel includes N scan electrodes, N common electrodes, M address electrodes, and N rows and M columns of lighting cells. The ith row of lighting cells among the N rows of lighting cells is corresponding to the ith scan electrode among the N scan electrodes and the ith common electrode among the N common electrodes. The jth lighting cell in the ith row of lighting cells is corresponding to the jth address electrode among the M address electrodes. During a sustain period, an ith scan voltage is applied to the ith scan electrode, an ith common voltage is applied to the ith common electrode, a jth address voltage is applied to the jth address electrode, the ith common voltage comprises an AC voltage, and the ith scan voltage and the jth address voltage are substantially DC voltages.

### BACKGROUND OF THE INVENTION

1. Field of the Invention

The invention relates to a display apparatus, and more specifically, to a shadow mask plasma display apparatus.

2. Description of the Prior Art

A plasma display panel (PDP) has many advantages such as high lightness, high efficiency, high contrast, high writing speed, and low cost. Thus, it is one of the current mainstream technologies of large-sized digital flat display panels.

As shown in FIG. 1A, a conventional plasma display panel 10 includes three main parts: a front plate 12, a back plate 14, and a shadow mask 16 between the front plate 12 and the back plate 14.

In general, the front plate 12 includes a first glass substrate 121, a plurality of scan electrodes 122, a transparent dielectric layer 124, and a first protective layer 125. The back plate 14 includes a second glass substrate 141, a plurality of address electrodes 142 (only one address electrode is shown in FIG. 1A), a dielectric layer 143, and a second protective layer 144. The shadow mask 16 includes a plurality of barrier ribs 161 and a plurality of color phosphors 162. In this example, the marks 162A, 162B, and 162C represent red, green, and blue phosphors respectively.

Each of the independent spaces containing the color phosphors 162 among the barrier ribs 161 can be seen as a lighting cell. These lighting cells are filled with a mixture of noble gases such as He, Ne, Xe, etc. By controlling the scan electrode 122 122 and the address electrode 142, the control circuit (not shown in the figure) of the plasma display panel 10 can decide whether the lighting cells radiate and their radiation strength. When a high voltage difference is generated between the scan electrode 122 and the address electrode 142 corresponding to a certain lighting cell, the gas of the lighting cell will be excited and then generates discharge effect. After enough wall charges is accumulated, the lighting cell will have enough voltage to generate gas discharge during a sustain period. The accordingly generated ultraviolet rays will further excite the color phosphors 162 in the lighting cell to generate visible lights of red, green, or blue.

The transparent dielectric layer 124 and the dielectric layer 143 are also called dielectric layers. They can store charges and achieve memory effect to keep images. The function of the first protective layer 125 and the second protective layer 144 is to prevent wearing out of the electrodes.

FIG. 1B is a schematic diagram of the shadow mask 16, the scan electrodes 122, and the address electrodes 142 viewed along the direction 18. As shown in FIG. 1B, the scan electrode 122 is perpendicular to the address electrode 142; each of the lighting cells spread with color phosphors 162 are arranged in order on the same plane with the barrier ribs 161 as their frame.

In practical applications, when a certain lighting cell is assigned to be lightened, the scan electrode 122 and the address electrode 142 corresponding to the lighting cell will form wall charges within the lighting cell during an address period. Afterward, the scan electrode 122 and the address electrode 142 will provide appropriate voltage to make the gas in the lighting cell generate discharge effect during a sustain period. Referring to FIG. 1C, FIG. 1C shows an example of the voltage provided to the scan electrode 122 in the sustain period. In general, the voltage provided to the scan electrode 122 includes an alternating voltage, and the voltage provided to the address electrode 142 is a direct voltage.

Referring to FIG. 2, FIG. 2 is a schematic diagram of opposite discharge between the scan electrode 122 and the address electrode 142 corresponding to a certain lighting cell. In the prior art, the discharge distance between the scan electrode 122 and the address electrode 142 is about equal to the distance between the front plate 12 and the back plate 14, and the distance also equals to the thickness of the shadow mask 16 (generally 90˜150 μm).

As those skilled in the art know, the discharge distance is in direct proportion to the discharge efficiency and the lightness of the lighting cell. That is to say, the lightness can be improved by increasing the discharge distance. However, it is not easy to produce a shadow mask of high thickness, and the cost is also high. Besides, the thickness of the shadow mask 16 is also in direct proportion to the firing voltage between the scan electrode 122 and the address electrode 142. Although the lightness can be improved by increasing the thickness of the shadow mask, a high firing voltage is unfavorable to surrounding driving circuits. Thus, increasing the thickness of the shadow mask is not a good solution to improve lightness.

Moreover, conventional manufacturing procedures of large-sized plasma display panels can not ensure that the planes of the front plate 12, the back plate 14, and the shadow mask 16 opposite to each other will be absolutely smooth. This causes some differences in the discharge distance among various parts of the same plasma display panel. And, the different discharge distances will result in the difference of the electric driving characteristic among the areas of the plasma display panel. Therefore, the image quality on the plasma display panel will be debased.

Beside the above problems of lightness and smoothness, another drawback of the prior art is that only one discharge area exists in each of the lighting cells. As shown in FIG. 1B, each of the lighting cells in the prior art is in a rectangular form. Because the electric field generated by the scan electrode 122 and the address electrode 142 is concentrated in the central part of the lighting cell, the color phosphors laid on other parts of the lighting cell are not fully utilized. Thus, the central part of the lighting cell will wear out faster and have shorter lifespan than other parts of the lighting cell.

### SUMMARY OF THE INVENTION

In order to solve the above problems, the invention provides a novel structure of plasma display panels.

According to the invention, a preferred embodiment is a plasma display panel including a front plate, a back plate, and N rows and M columns of lighting cells. N and M are both positive integers. The front plate includes N scan electrodes and N common electrodes. The back plate includes M address electrodes. The ith row of lighting cells among the N rows of lighting cells corresponds to the ith scan electrode among the N scan electrodes and the ith common electrode among the N common electrodes, wherein i is an integer index ranging from 1 to N. The jth lighting cell in the ith row of lighting cells corresponds to the jth address electrode among the M address electrodes, wherein j is an integer index ranging from 1 to M. During a first sustain period for lightening the jth lighting cell in the ith row of lighting cells, an ith scan voltage is applied to the ith scan electrode, an ith common voltage is applied to the ith common electrode, and a jth address voltage is applied to the jth address electrode. The ith common voltage includes a first AC voltage, and the ith scan voltage and the jth address voltage are substantially DC voltages.

The advantage and spirit of the invention may be understood by the following recitations together with the appended drawings.

### BRIEF DESCRIPTION OF THE APPENDED DRAWINGS

FIG. 1A and FIG. 1B show the structure of a conventional plasma display panel; FIG. 1C shows an example of voltage provided to the scan electrode in the sustain period.

FIG. 2 is a schematic diagram of opposite discharge in a certain lighting cell in the prior art.

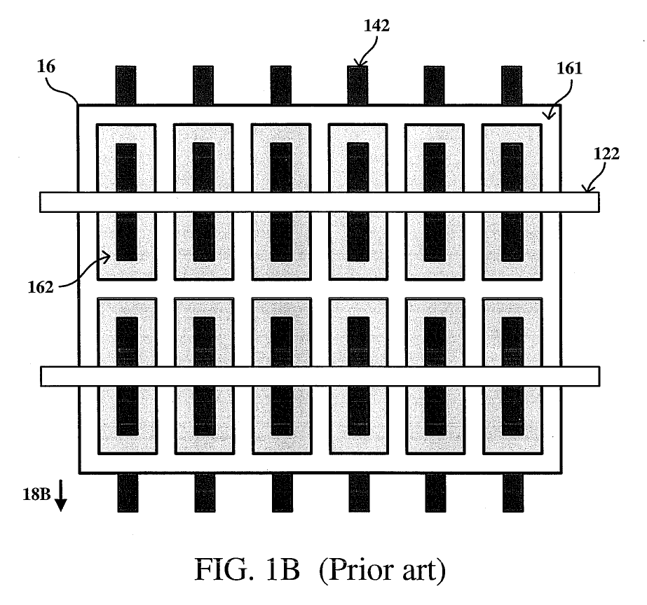

FIG. 3 is a schematic diagram of a plasma display panel according to a preferred embodiment of the invention.

FIG. 4 shows an example of voltage provided to the common electrode in the sustain period.

FIG. 5 is a schematic diagram of opposite discharge in certain lighting cell in the invention.

FIG. 6 shows the common voltages corresponding to two adjacent rows of lighting cells.

FIG. 7 shows the respective current directions of two adjacent rows of lighting cells when the electrodes discharge after providing the above common voltages.

FIG. 8 shows the scan electrode and common electrode after their shapes are changed.

FIG. 9 shows the shadow mask of another preferred embodiment according to the invention.

FIG. 10 is a schematic diagram of the plasma display panel including 2*N common electrodes.

FIG. 11 shows an example of the common voltage corresponding to two adjacent rows of lighting cells during a sustain period.

### DETAILED DESCRIPTION OF THE INVENTION

The invention provides a plasma display panel with high lightness, long lifetime, and high yield of manufacturing process.

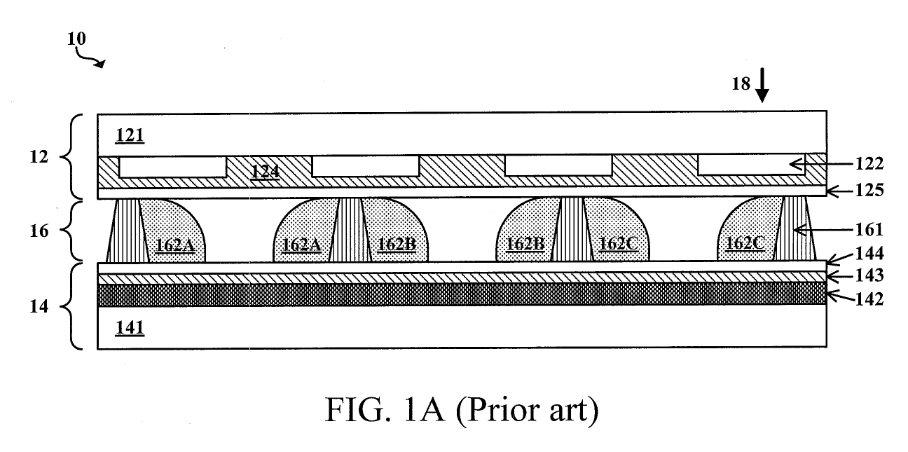

According to the invention, a preferred embodiment is a plasma display panel including a front plate, a back plate, and N rows and M columns of lighting cells. N and M are both positive integers. In practical applications, as shown in FIG. 1A and FIG. 1B, the lighting cells are a plurality of spaces separated by a shadow mask located between the front plate and the back plate; the shadow mask can include a plurality of barrier ribs and a plurality of color phosphors.

In the embodiment according to the invention, the front plate includes N scan electrodes and N common electrodes. The back plate includes M address electrodes. The ith row of lighting cells among the N rows of lighting cells corresponds to the ith scan electrode among the N scan electrodes and the ith common electrode among the N common electrodes, wherein i is an integer index ranging from 1 to N. And, the jth lighting cell in the ith row of lighting cells corresponds to the jth address electrode among the M address electrodes, wherein j is an integer index ranging from 1 to M. In other words, each row of lighting cells corresponds to a scan electrode and a common electrode; each column of lighting cells corresponds to an address electrode.

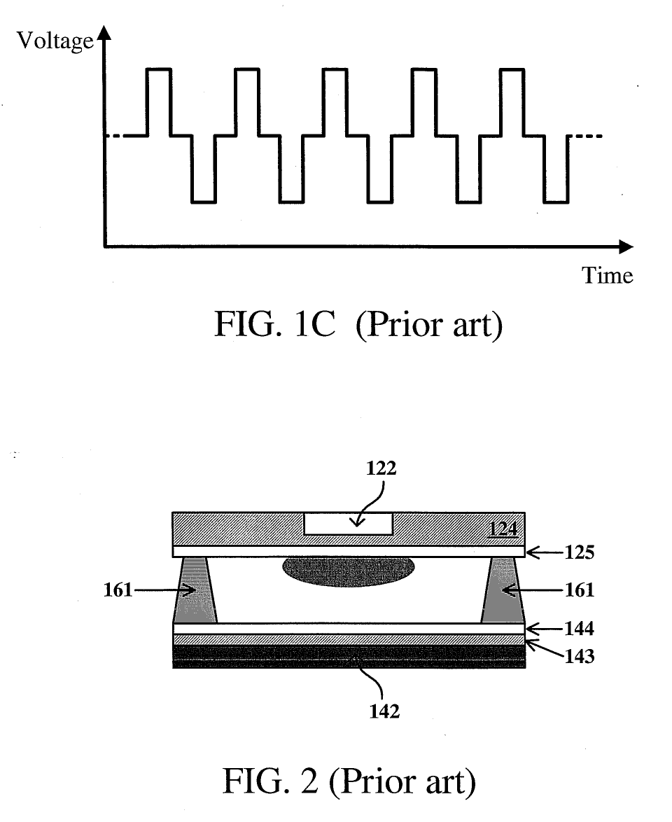

Referring to FIG. 3, FIG. 3 is a schematic diagram of the preferred embodiment. In order to make the schematic diagram clearer, the front plate and the back plate are not shown in the diagram. Mark 30 represents the shadow mask located between the front plate and the back plate. Mark 32 represents the lighting cells. Marks 34, 36, and 38 represent a scan electrode, a common electrode, and an address electrode respectively.

According to the invention, when a certain lighting cell 32 is assigned to be lightened, the scan electrode 34, common electrode 36, and address electrode 38 corresponding to the lighting cell 32 are operated to generate discharge effect in the lighting cell 32.

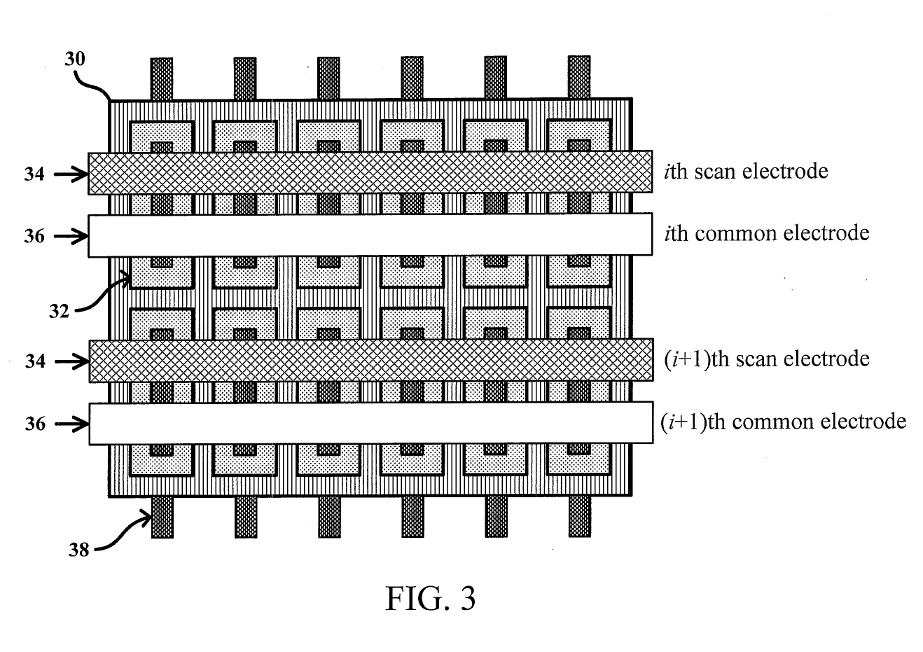

During a first sustain period for lightening the jth lighting cell in the ith row of lighting cells 32, an ith scan voltage is applied to the ith scan electrode 34, an ith common voltage is applied to the ith common electrode 36, and a jth address voltage is applied to the jth address electrode 38. As shown in FIG. 4, the ith common voltage includes a first AC voltage. The ith scan voltage and the jth address voltage are substantially DC voltages. Because each of scan voltages is substantially DC voltage, the load for a scan chip caused by voltage differences between adjacent scan electrodes 34 can be reduced. In this way, the lifespan of the scan chip of a PDP can be increased.

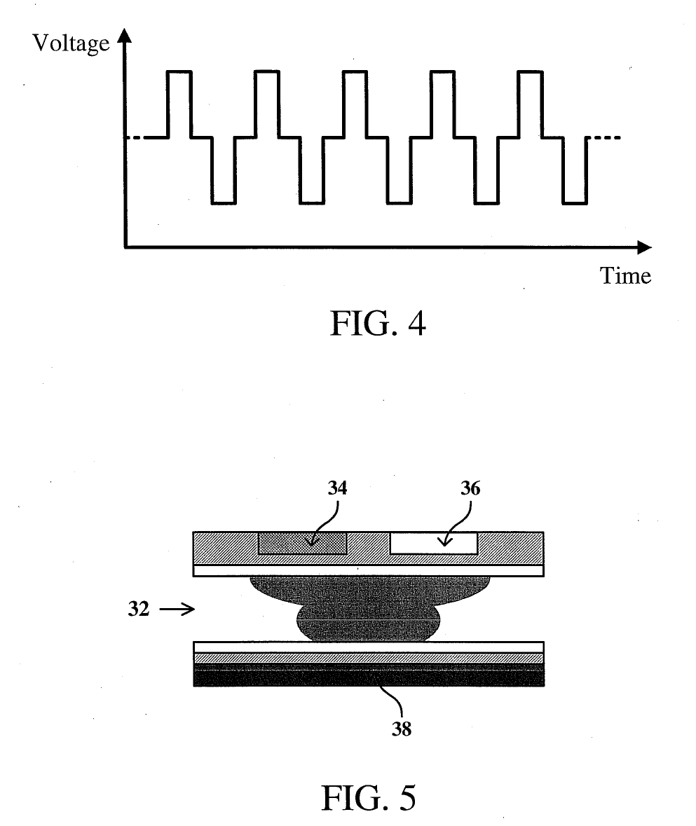

Referring to FIG. 5, FIG. 5 shows the discharge condition in the lighting cell 32 according to the invention. Discharge effect is generated not only between the scan electrode 34 and the address electrode 38, but also between the scan electrode 34 and the common electrode 36. Due to the effect of the address electrode 38, discharge effect between the scan electrode 34 and the common electrode 36 can be far away from the front plate and can move toward the address electrode 38. This increases the discharge area within the lighting cell 32. Compared to those in the prior art in which each of the lighting cells has only one discharge area concentrated in the central part, the discharge distance in this invention is longer, and the lighting efficiency is higher in the lighting cell 32. The color phosphors spread on the upside and the downside of the lighting cell 32 can also be fully utilized. By enlarging the discharge area within the lighting cell 32, this invention can further prevent the problem of wearing out the central parts of the lighting cell 32 too fast in the prior art.

Besides, according to the invention, the discharge gap that dominates the driving characteristics of the lighting cell 32 is related to the distance between the scan electrode 34 and the common electrode 36 instead of the thickness of the shadow mask 30. Because the distance between the scan electrode 34 and the common electrode 36 can be easily controlled in the manufacturing process, the plasma display display panel, according to the invention, can prevent the problem of varying driving characteristics in the prior art.

Another advantage of the invention is that the effect of the thickness of the shadow mask 30 to the firing voltage is substantially reduced. This is because the discharge gap that dominates the driving characteristics is related to the distance between the scan electrode 34 and the common electrode 36. Thus, increasing the thickness of the shadow mask 30 to improve the lightness is not harmful to surrounding driving circuits.

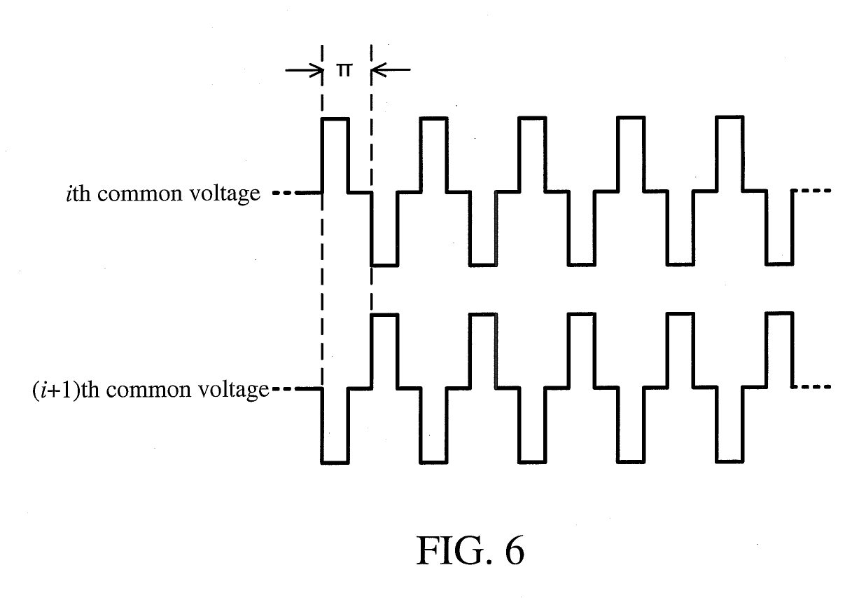

In practical applications, the plasma display panel, according to the invention, can further control the common voltage provided to the common electrode 36 to reduce electromagnetic interference. Referring to FIG. 6, FIG. 6 shows the common voltages corresponding to two adjacent rows of lighting cells 32. During a second sustain period for lightening the jth lighting cell in the (i+1)th row of lighting cells 32, an (i+1)th common voltage is applied to the (i+1)th common electrode among the N common electrodes 36. The (i+1)th scan voltage includes a second AC voltage. The amplitudes of the first AC voltage and the second AC voltage are substantially the same, and the first AC voltage and the second AC voltage are substantially out of phase. That is to say, during the sustain period, the amplitudes of the scan voltages corresponding to two adjacent rows of lighting cells 32 are the same, and the phase difference is about 180°.

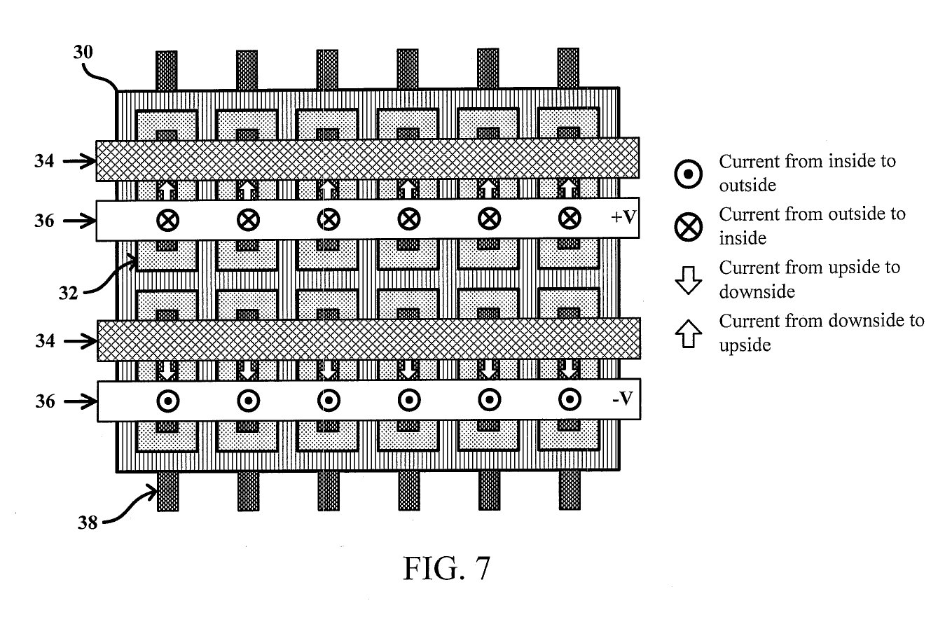

FIG. 7 shows the respective current directions of two adjacent rows of lighting cells 32 when the electrodes discharge after providing the above common voltages. As shown in FIG. 7, because the common voltages of two adjacent rows of lighting cells 32 are out of phase, the current directions of two adjacent rows of lighting cells 32 are also opposite. In this way, the electromagnetic interference generated by two adjacent rows of lighting cells 32 will be cancelled out. Besides, the opposite current directions can reduce 50% of peak current for the entire circuit. This not only reduces the cost of device but also increases the lifespan of the plasma display panel. Moreover, this embodiment can also effectively suppress noise problems due to the opposite vibrating direction generated during the gas discharge.

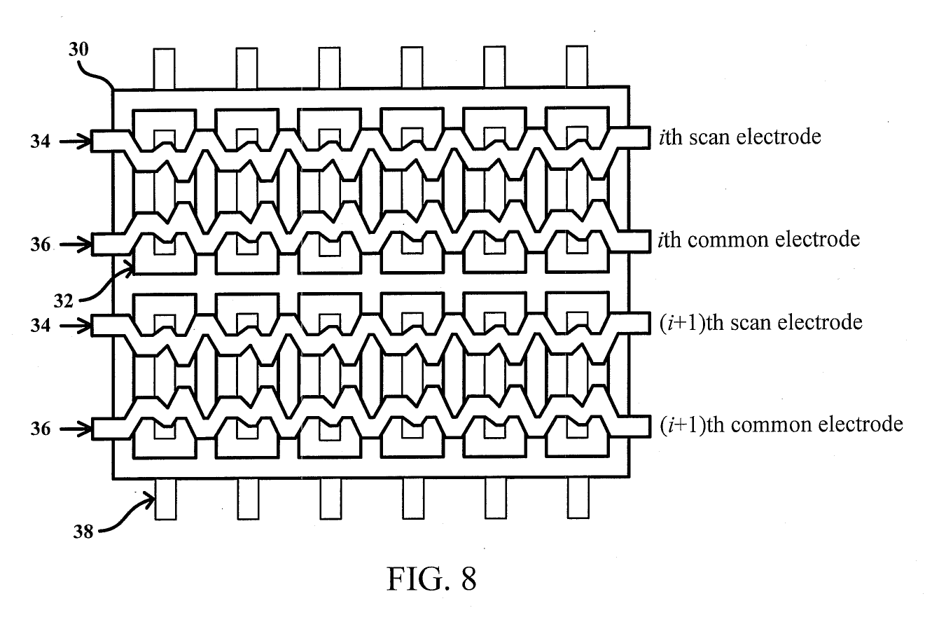

In practical applications, the plasma display panel, according to the invention, can also change the shape of the scan electrode 34 and the common electrode 36 to further improve the lighting efficiency. FIG. 8 shows the scan electrode 34 and common electrode 36 after their shapes are changed. As shown in FIG. 8, each of the lighting cells 32 includes a first lighting region and a second lighting region respectively. For each of the lighting cells 32, the distances between the scan electrode 34 and the common electrode 36 corresponding to the first lighting regions are larger than those corresponding to the second lighting regions. That is to say, the discharge gap of the first lighting region is larger than that of the second lighting region in each of the lighting cells 32.

The advantage of this embodiment is that the parts with smaller discharge gap can provide lower firing voltage while the parts with larger discharge gap can generate higher lightness. The lower firing voltage area will generate discharge phenomenon earlier; on the contrary, in the higher firing voltage area, the generation time of discharge phenomenon will be later. By doing so, this embodiment can lower the discharge peak current to reduce the load of the circuit system. Besides, the electrode shape shown in FIG. 8 can disperse the current to enlarge the discharge area. This not only can increase the lifespan of the panel but also improve the lighting efficiency.

In practical applications, the front plate of the above mentioned plasma display panel can further include a first glass substrate, a transparent dielectric layer, and a first protective layer. The back plate of the plasma display panel can further include a second glass substrate, a dielectric layer, and a second protective layer.

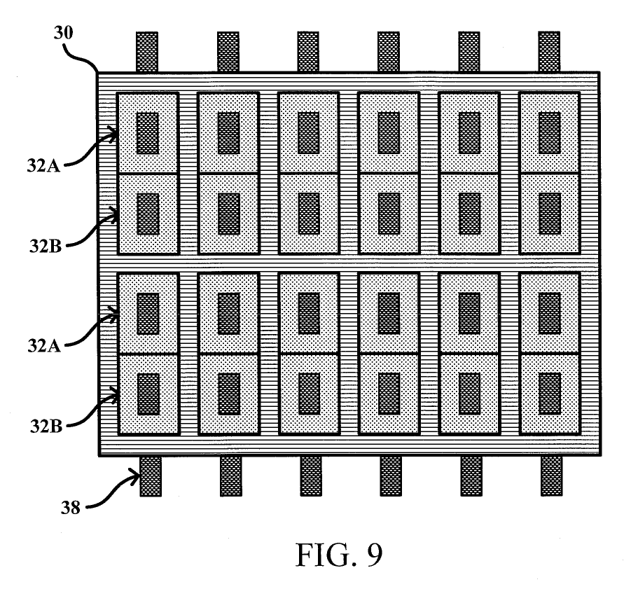

Referring to FIG. 9, FIG. 9 shows the shadow mask of another preferred embodiment according to the invention. In this embodiment, each of the lighting cells of the plasma display panel is divided into a first sub-cell 32A and a second sub-cell 32B. When a target lighting cell among the lighting cells is assigned to be lightened, both the first sub-cell 32A and the second sub-cell 32B of the target lighting cell are operated to be lightened. Dividing a lighting cell into two sub-cells can increase the spread area of color phosphors and can improve the utilization efficiency of ultraviolet rays.

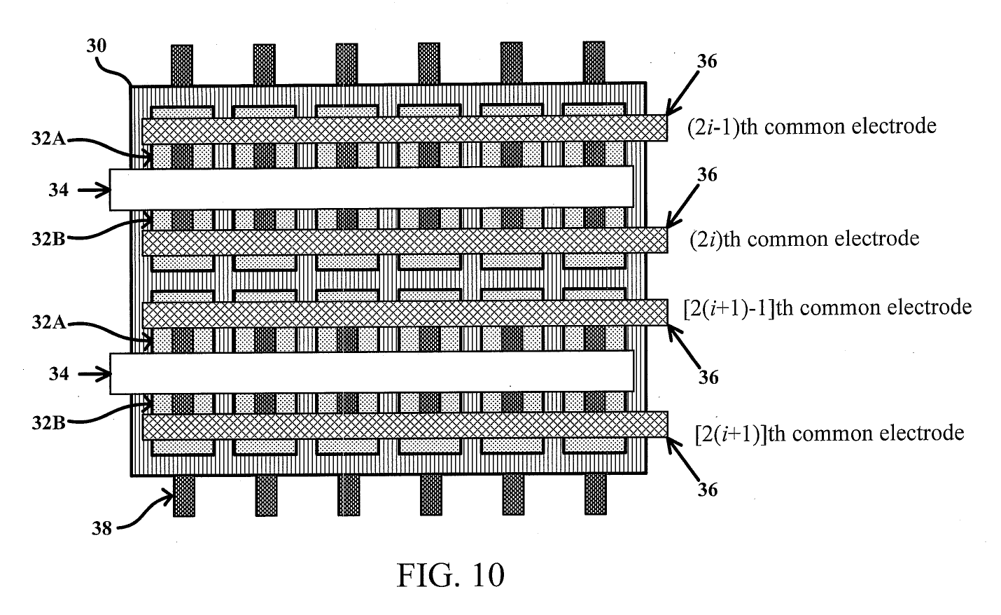

As shown in FIG. 10, all the first sub-cells 32A and the second sub-cells 32B in the same row of the lighting cells can share a scan electrode 34. According to the invention, the first sub-cells 32A and the second sub-cells 32B can also have their own common electrodes 36 respectively. That is to say, if a plasma display panel includes N rows and M columns of lighting cells 32, the front plate can include N scan electrodes 34 and 2*N common electrodes 36, and the back plate can include M address electrodes 38.

FIG. 10 illustrates an example of the plasma display panel including 2*N common electrodes 36. The first sub-cells 32A in the ith row of lighting cells 32 among the N rows of lighting cells 32 correspond to the (2i−1)th common electrode 36 among the 2*N common electrodes 36 and the ith scan electrode 34 among the N scan electrodes 34. The second sub-cells 32B in the ith row of lighting cells 32 among the N rows of lighting cells 32 correspond to the (2i)th common electrode 36 among the 2*N common electrodes 36 and the ith scan electrode 34 among the N scan electrodes 34. It is the same as the former embodiment that the jth lighting cell 32 in the ith row of lighting cells 32 corresponds to the jth address electrode 38 in the M address electrodes 38.

It should be noticed, in the embodiment, the second sub-cells 32B of the (i+1)th row of lighting cell 32 are adjacent to the second sub-cells 32B of the ith row of lighting cell 32. Thus, the [2(i+1)]th common electrode 36 is adjacent to the (2i)th common electrode 36. More specifically, the arrangement of the lighting cells 32 is repeated with a unit of the first sub-cell 32A, the second sub-cell 32B, the second sub-cell 32B, and the first sub-cell 32A.

When the jth lighting cell 32 in the ith row of lighting cells 32 is assigned to be lightened, the (2i−1)th common electrode 36, the (2i)th common electrode 36, the ith scan electrode 34, and the jth address electrode 38 are operated to generate discharge effects in the first sub-cell 32A and second sub-cell 32B of the jth lighting cell in the ith row of lighting cells 32.

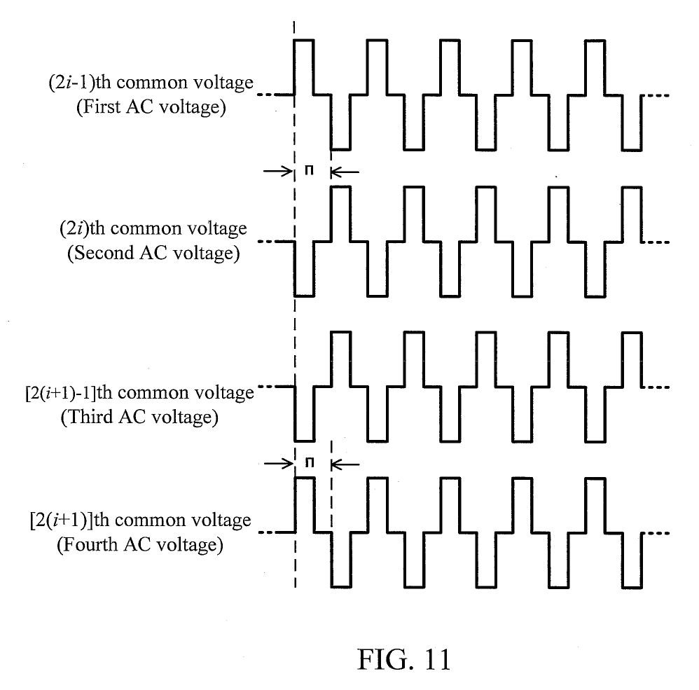

The advantage of making the first sub-cells 32A and the second sub-cells 32B have their own scan electrodes 34 respectively is that the designer can adjust the scan voltages with more flexibility. FIG. 11 shows an example of the common voltages corresponding to two adjacent rows of lighting cells during a sustain period.

In the example of FIG. 11, during a first sustain period for lightening the jth lighting cell in the ith row of lighting cells, a (2i−1)th common voltage is applied to the (2i−1)th common electrode, and a (2i)th common voltage is applied to the (2i)th common electrode. The (2i−1)th common voltage includes a first AC voltage; the (2i)th common voltage includes a second AC voltage, the pulses of first AC voltage and the pulses of second AC voltage are substantially out of phase.

During a second sustain period for lightening the jth lighting cell in the (i+1)th row of lighting cells, a [2*(i+1)−1]th common voltage is applied to the [2*(i+1)−1]th common electrode among the 2*N common electrodes, and a [2*(i+1)]th common voltage is applied to the [2*(i+1)]th common electrode among the 2*N common electrodes. The [2*(i+1)−1]th common voltage includes a third AC voltage; the [2*(i+1)]th common voltage includes a fourth AC voltage. As shown in FIG. 11, the pulses of the first AC voltage and the pulses of the fourth AC voltage are substantially in phase. On the other hand, the pulses of the second AC voltage and the pulses of the adjacent third AC voltage are substantially in phase. Besides, the ith scan voltage and the jth address voltage are substantially DC voltages. The current peak of the entire circuit can be lowered by dispersing the times at which each of the scan voltages reaches voltage peaks; thus, the load of the circuit system can be reduced. Besides, during the first sustain period, the number of pulse included by the first AC voltage can be different from that included by the second AC voltage. For example, the first AC voltage can include ten periodic pulses during the first sustain period; the second AC voltage can include nine periodic pulses during the first sustain period. By doing so, the lightness of the first sub-cell 32A and the second sub-cell 32B can be different, and the lightness variability of plasma display panel can accordingly be increased.

With the above example and explanation, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A plasma display panel (PDP), comprising:
N rows and M columns of lighting cells, wherein N and M are positive integers;
a front plate comprising N scan electrodes and N common electrodes, the ith row of lighting cells among the N rows of lighting cells being corresponding to the ith scan electrode among the N scan electrodes and the ith common electrode among the N common electrodes, wherein i is an integer index ranging from 1 to N; and
a back plate comprising M address electrodes, the jth lighting cell in the ith row of lighting cells being corresponding to the jth address electrode among the M address electrodes, wherein j is an integer index ranging from 1 to M;
wherein during a first sustain period for lightening the jth lighting cell in the ith row of lighting cells, an ith scan voltage is applied to the ith scan electrode, an ith common voltage is applied to the ith common electrode, a jth address voltage is applied to the jth address electrode, the ith common voltage comprises a first AC voltage, and the ith scan voltage and the jth address voltage are substantially DC voltages.

2. The PDP of claim 1, wherein during a second sustain period for lightening the jth lighting cell in the (i+1)th row of lighting cells, an (i+1)th common voltage is applied to the (i+1)th common electrode among the N common electrodes, the (i+1)th common voltage comprises a second AC voltage, the amplitudes of the first AC voltage and the second AC voltage are substantially the same, and the first AC voltage and the second AC voltage are substantially out of phase.

3. The PDP of claim 1, wherein each of the lighting cells in the ith row of lighting cells comprises a first lighting region and a second lighting region, the distances between the ith scan electrode and the ith common electrode, corresponding to the first lighting regions, are larger than those corresponding to the second lighting regions.

4. The PDP of claim 1, wherein the lighting cells are a plurality of spaces separated by a shadow mask located between the front plate and the back plate.

5. The PDP of claim 1, wherein the shadow mask comprises a plurality of barrier ribs and a plurality of color phosphors.

6. The PDP of claim 1, wherein the front plate further comprises a first glass substrate, a transparent dielectric layer, and a first protective layer.

7. The PDP of claim 1, wherein the back plate further comprises a second glass substrate, a dielectric layer, and a second protective layer.

8. The PDP of claim 1, wherein each of the lighting cells respectively comprises a first sub-cell and a second sub-cell, when a target lighting cell among the lighting cells is assigned to be lightened, both the first sub-cell and the second sub-cell of the target lighting cell are lightened.

9. A plasma display panel (PDP), comprising:
N rows and M columns of lighting cells, each of the lighting cells respectively comprising a first sub-cell and a second sub-cell, wherein N and M are positive integers;
a front plate comprising 2*N common electrodes and N scan electrodes, the first sub-cells in the ith row of lighting cells among the N rows of lighting cells being corresponding to the (2i−1)th common electrode among the 2*N common electrodes and the ith scan electrode among the N scan electrodes, the second sub-cells in the ith row of lighting cells among the N rows of lighting cells being corresponding to the (2i)th common common electrode among the 2*N common electrodes and the ith scan electrode among the N scan electrodes, wherein i is an integer index ranging from 1 to N; and
a back plate comprising M address electrodes, the jth lighting cell in the ith row of lighting cells being corresponding to the jth address electrode among the M address electrodes, wherein j is an integer index ranging from 1 to M;
wherein during a first sustain period for lightening the jth lighting cell in the ith row of lighting cells, a (2i−1)th common voltage is applied to the (2i−1)th common electrode, a (2i)th common voltage is applied to the (2i)th common electrode, the (2i−1)th common voltage comprises a first AC voltage, the (2i)th common voltage comprises a second AC voltage, and the first AC voltage and the second AC voltage are substantially out of phase.

10. The PDP of claim 9, wherein the (i+1)th row of lighting cells among the N rows of lighting cells is corresponding to the [2(i+1)−1]th common electrode and the [2(i+1)]th common electrode among the 2*N common electrodes, during a second sustain period for lightening the jth lighting cell in the (i+1)th row of lighting cells, a [2(i+1)−1]th common voltage is applied to the [2(i+1)−1]th common electrode, a [2(i+1)]th common voltage is applied to the [2(i+1)]th common electrode, the [2(i+1)−1]th common voltage comprises a third AC voltage, the [2(i+1)]th common voltage comprises a fourth AC voltage, the fourth AC voltage and the first AC voltage are substantially in phase, and the third AC voltage and the second AC voltage are substantially in phase.

11. The PDP of claim 9, wherein during the first sustain period, the number of pulse comprised by the first AC voltage is different from the number of pulse comprised by the second AC voltage.
